(19) United States
(12) Patent Application Publication
(10) Pub. No.: US 2022/0035481 A1
(43) Pub. Date: Feb. 3, 2022

(54) TOUCH SENSING APPARATUS

(71) Applicant: FlatFrog Laboratories AB, Lund (SE)

(72) Inventors: Håkan Bergström, Torna-Hällestad (SE); Tomas Svensson, Limhamn (SE)

(21) Appl. No.: 17/277,043

(22) PCT Filed: Oct. 7, 2019
(86) PCT No.: PCT/EP2019/077054

§ 371 Date: Mar. 17, 2021

(30) Foreign Application Priority Data
Oct. 20, 2018 (SE) 1830300-8

(51) Int. Cl. G06F 3/042; G02B 3/08

(52) U.S. Cl. CPC G06F 3/0428; G02B 3/08

(57) ABSTRACT

A touch sensing apparatus is disclosed comprising a panel that defines a touch surface extending in a plane having a normal axis, emitters and detectors arranged along a perimeter of the panel, a light directing element arranged adjacent the perimeter, the emitters are arranged to emit a respective beam of light and the light directing element is arranged to receive the beam of light through a first surface and couple out the beam of light through a second surface to direct the beam of light across the touch surface substantially parallel to the touch surface, the beam of light is received through the first surface at a first distance from the touch surface and is deflected by the light directing element to the second surface to couple out the beam of light at a second distance from the touch surface, wherein the first distance is greater than the second distance.

### TECHNICAL FIELD

The present invention relates to a touch-sensing apparatus that operate by propagating light by diffusive light scattering above a thin panel, and in particular to optical solutions for defining the location of the light paths.

### BACKGROUND ART

In one category of touch-sensitive panels known as ‘above surface optical touch systems’, a set of optical emitters are arranged around the periphery of a touch surface to emit light that is reflected to travel and propagate above the touch surface. A set of light detectors are also arranged around the periphery of the touch surface to receive light from the set of emitters from above the touch surface. I.e. a grid of intersecting light paths are created above the touch surface, also referred to as scanlines. An object that touches the touch surface will attenuate the light on one or more propagation paths of the light and cause a change in the light received by one or more of the detectors. The coordinates, shape or area of the object may be determined by analyzing the received light at the detectors.

The geometry of the scanlines affects factors such as signal-to-noise ratio, detection accuracy, resolution, the presence of artefacts etc, in the touch detection process. Problems with previous prior art touch detection systems relate to sub-optimal performance with respect to the aforementioned factors. While prior art systems aim to improve upon these factors, e.g. the detection accuracy, there is often an associated compromise in terms of having to incorporate more complex and expensive opto-mechanical modifications to the touch system. This typically results in a less compact touch system, and a more complicated manufacturing process, being more expensive. To reduce system cost, it may be desirable to minimize the number of electro-optical components.

### SUMMARY

An objective is to at least partly overcome one or more of the above identified limitations of the prior art.

One objective is to provide a touch-sensitive apparatus based on “above-surface” light propagation which provides for improving the accuracy of the touch detection while being robust and easy to assemble.

One or more of these objectives, and other objectives that may appear from the description below, are at least partly achieved by means of touch-sensitive apparatuses according to the independent claims, embodiments thereof being defined by the dependent claims.

According to a first aspect a touch sensing apparatus is provided comprising a panel that defines a touch surface extending in a plane having a normal axis, a plurality of emitters and detectors arranged along a perimeter of the panel, a light directing element arranged adjacent the perimeter, wherein the emitters are arranged to emit a respective beam of light and the light directing element is arranged to receive the beam of light through a first surface and couple out the beam of light through a second surface to direct the beam of light across the touch surface substantially parallel to the touch surface, wherein the beam of light is received through the first surface at a first distance from the touch surface and is deflected by the light directing element to the second surface to couple out the beam of light at a second distance from the touch surface, wherein the first distance is greater than the second distance.

According to a second aspect a touch sensing apparatus is provided comprising a panel that defines a touch surface extending in a plane having a normal axis, a plurality of emitters and detectors arranged along a perimeter of the panel, a light directing element arranged adjacent the perimeter, the emitters are arranged to emit a respective beam of light and the light directing element is arranged to receive the beam of light through a first surface and couple out the beam of light through a second surface to direct the beam of light across the touch surface substantially parallel to the touch surface, the first surface extends between a base surface of the light directing element and a top surface of the light directing element, opposite the base surface, a seal arranged between the base surface and a frame element, the seal is arranged radially outside an edge of the panel and is arranged against at least a portion of the base surface extending outside the edge, the seal is substantially flush with the plane of the touch surface with respect to the normal axis, so that the base surface is substantially flush with the plane of the touch surface.

Further examples of the invention are defined in the dependent claims, wherein features for the first aspect may be implemented for the second aspect, and vice versa.

Some examples of the disclosure provide for a touch sensing apparatus with improved touch detection accuracy.

Some examples of the disclosure provide for a touch sensing apparatus that is more reliable to use.

Some examples of the disclosure provide for a touch sensing apparatus that is easier to manufacture.

Some examples of the disclosure provide for a touch sensing apparatus that is less costly to manufacture.

Some examples of the disclosure provide for a more robust touch sensing apparatus.

Still other objectives, features, aspects and advantages of the present disclosure will appear from the following detailed description, from the attached claims as well as from the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

These and other aspects, features and advantages of which examples of the invention are capable of will be apparent and elucidated from the following description of examples of the present invention, reference being made to the accompanying drawings, in which;

FIG. 1a is a schematic illustration, in a cross-sectional side view, of a touch sensing apparatus according to one example;

FIG. 1b is a schematic illustration, in a cross-sectional side view, of a detail of the touch sensing apparatus of FIG. 1a;

FIG. 1c is a schematic illustration, in a cross-sectional side view, of a detail of the touch sensing apparatus of FIG. 1a;

FIG. 2a is a schematic illustration, in a cross-sectional side view, of a detail of a touch sensing apparatus, where a light directing element thereof comprises Fresnel lenses;

FIG. 2b is a schematic illustration, in a cross-sectional side view, of a detail of a touch sensing apparatus, where a light directing element comprises tilted surfaces;

FIG. 2c is a schematic illustration, in a cross-sectional side view, of a detail of a touch sensing apparatus, where a light directing element comprises a lens and a tilted surface;

FIG. 2d is a schematic illustration, in a cross-sectional side view, of a detail of a touch sensing apparatus, where a light directing element comprises a tilted surface and a lens;

FIG. 3 is a schematic illustration, in a cross-sectional side view, of a touch sensing apparatus according to one example, where reflective surfaces are arranged along the light path;

FIG. 4 is a schematic illustration, in a cross-sectional side view, of a detail of a touch sensing apparatus, where a light transmissive sealing element is arranged between the tilted second surface and the touch surface;

FIG. 5a is a schematic illustration, in a cross-sectional side view, of a detail of a touch sensing apparatus according to one example;

FIG. 5b is a schematic illustration, in a top-down view, of the detail in FIG. 5a according to one example;

FIG. 6 is a schematic illustration, in a cross-sectional side view, of a touch sensing apparatus according to one example, where light directing elements direct light between emitters and receivers;

FIG. 7 is a schematic illustration, in a cross-sectional side view, of a detail of a touch sensing apparatus according to one example;

FIG. 8 is a schematic illustration, in a cross-sectional side view, of a detail of a touch sensing apparatus according to one example; and

FIG. 9 is a schematic illustration, in a cross-sectional side view, of a detail of a touch sensing apparatus according to one example.

### DETAILED DESCRIPTION OF EXAMPLE EMBODIMENTS

In the following, embodiments of the present invention will be presented for a specific example of a touch-sensitive apparatus. Throughout the description, the same reference numerals are used to identify corresponding elements.

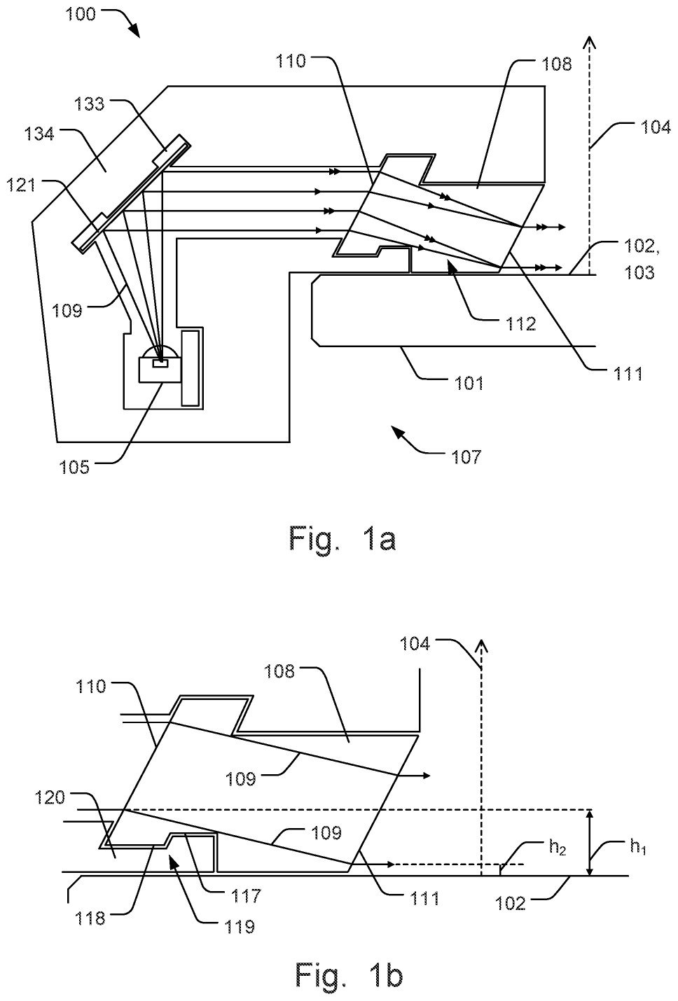

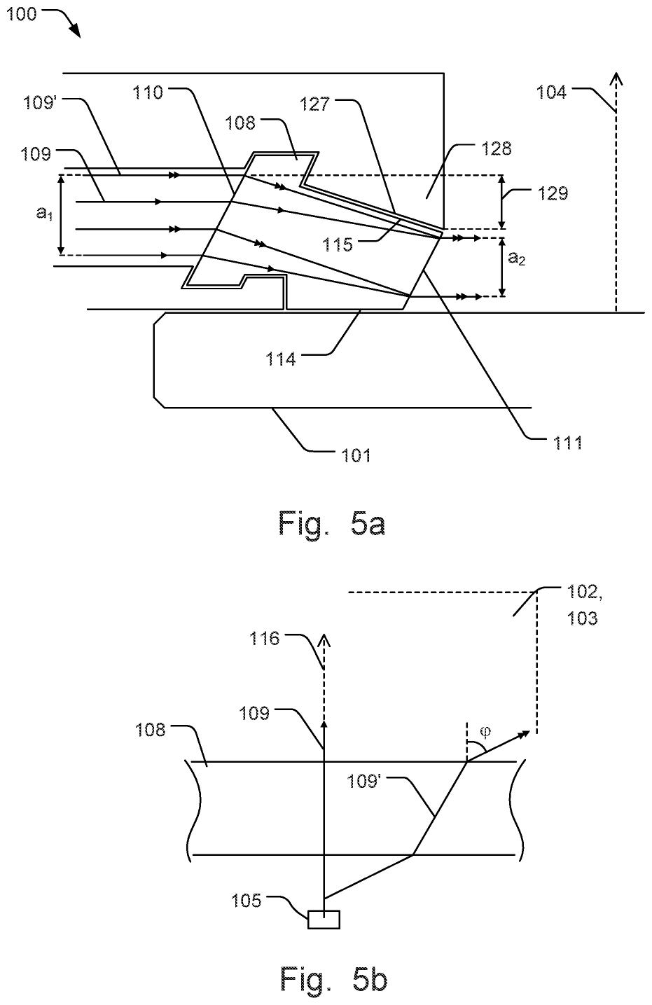

FIG. 1a is a schematic illustration, in a cross-sectional side view, of a touch sensing apparatus 100 comprising a panel 101 that defines a touch surface 102. The panel 101 may comprise a light transmissive panel. The panel 101 and the touch surface 102 thereof extends in a plane 103 which as a normal axis 104. The touch sensing apparatus 100 comprises a plurality of emitters 105 and detectors 106 arranged along a perimeter 107 of the panel 101. FIG. 1a show only an emitter 105 for clarity of presentation, while FIG. 6 illustrates how light is transmitted from an emitter 105 to a detector 106 across the touch surface 102. The touch sensing apparatus 100 comprises a light directing element 108 arranged adjacent the perimeter 107 of the panel 101. The emitters 105 are arranged to emit a respective beam of light 109, and the light directing element 108 is arranged to receive the beam of light 109 through a first surface 110 and couple out the beam of light 109 through a second surface 111 to direct the beam of light 109 across the touch surface 102, substantially parallel to the touch surface 102. FIG. 1b is a detailed view of a section of FIG. 1a, showing the light directing element 108 and the paths of the beams of light 109 entering and leaving the light directing element 108 through the first and second surfaces 110, 111, respectively. The light directing element 108 is arranged so that a beam of light 109 is received through the first surface 110 at a first distance (h₁) from the touch surface 102, and is deflected by the light directing element 108 to the second surface 111, to couple out the beam of light 109 substantially parallel with the touch surface 102 at a second distance (h₂) from the touch surface 102. The first distance (h₁) is greater than the second distance (h₂), as illustrated in FIG. 1b showing examples of the paths along which the light beams 109 propagate. A light beam 109 propagating between the first and second surfaces 110, 111, may thus be shifted a distance along the normal axis 104 corresponding to h₁-h₂. The light beams 109 leaving the second surface 111 propagate across the touch surface 102 as a light field having a certain height above the touch surface 102. Hence, light beams 109 are shifted towards the touch surface 102, when propagating through the light directing element 108, so that the height of a light field of such light beams 109 across the touch surface 102 is reduced. The height of the light field affects the accuracy of the touch detection. I.e. an object, such as a pen or finger, approaching the touch surface 102 will start to intersect the light field at a certain height, at which point the detection signal will start to indicate attenuation of the light. The detection signal typically varies while the object moves through the light field, until touching the touch surface 102. Reducing the height of the light field provides for improving the accuracy in detecting when the object is actually about to touch the touch surface 102, with less fluctuations in the detection signal. The increased accuracy improves the writing experience.

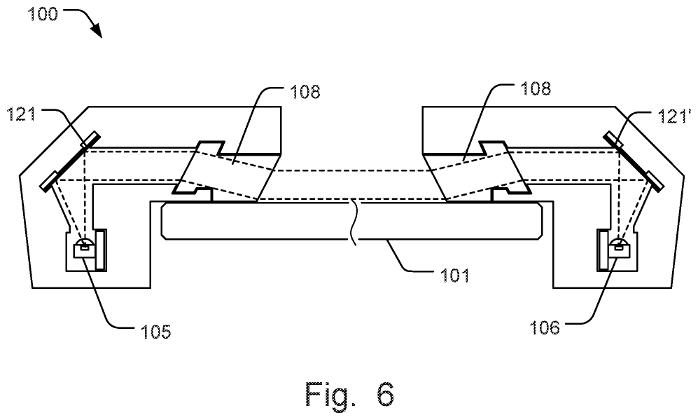

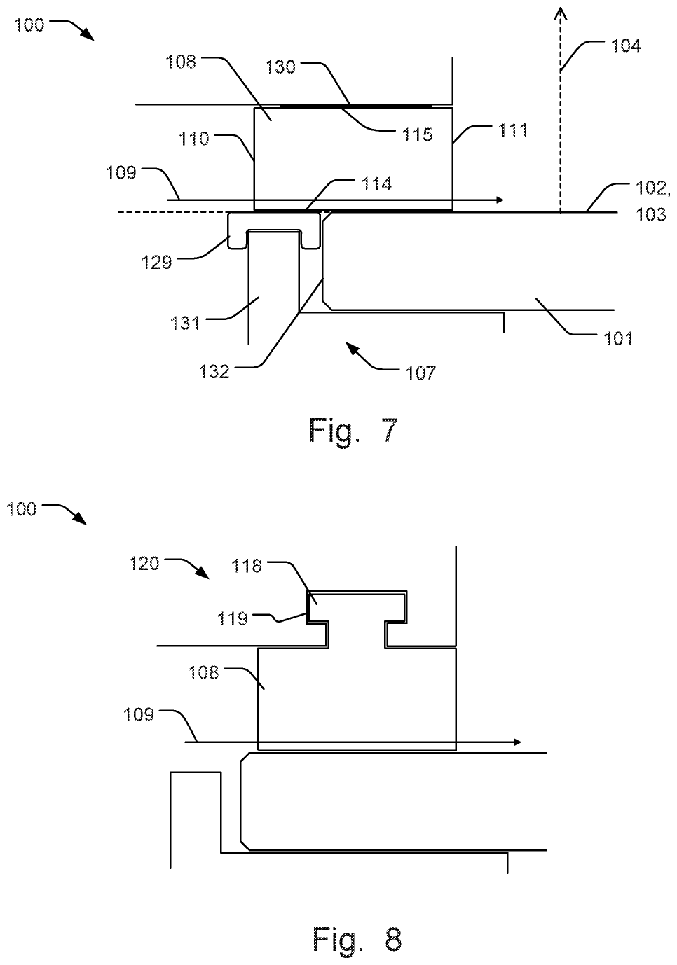

Having a light directing element 108 arranged to shift the beams of light 109 towards the touch surface 102 as described above provides for optimizing detection accuracy while allowing for utilizing the benefits of having a light directing element 108 receiving light beams 109 with a greater separation from the touch surface 102. E.g. shifting the light beams 109 from a first height (h₁) to a second, reduced height (h₂), allows for minimizing the second height (h₂) in relation to the touch surface 102 to attain the advantages as described above, while the first height (h₁) may be optimized in relation to e.g. the fixation of the light directing element 108. Such fixation needs to be robust in order to achieve a stable optical path for the light beams 109, and a reliable sealing of the interior components such as the emitters 105 and detectors 106 from the outside. At the same time, it is desirable to have a fixation mechanism which facilitates the assembly of the touch sensing apparatus 100 to make manufacturing less complex and involving less components, thereby facilitating mass production. Having the light beams 109 shifted as described above allows for greater flexibility in utilizing the first part of the light directing element 108 adjacent the first surface 110 as a fixation mechanism, without having to introduce separate fixation elements such as adhesives, while lowering the light field at the touch surface 102. For example, a bottom portion of the light directing element 108 facing the panel 101 may be utilized as a fixation mechanism, as schematically seen in FIG. 1a and as described in more detail below. The light beams 109 can be received at an increased height (h₁) relative the touch panel 101 and are thus not affected by having such fixation mechanism at the bottom portion (see e.g. surface denoted as 118 in FIG. 1b), while being shifted to the lower height (h₂) when propagating through the light directing element 109, reducing the height of the light field travelling across the touch surface 102. The accuracy of the touch detection of the touch sensing apparatus 100 can thus be improved while providing for a less complex assembly thereof. The advantageous benefits of reducing the height of the light field across the touch surface 102 is as described above are provided regardless of the fixation and sealing mechanism of the light directing element 108, i.e. also for the arrangement shown in the examples in FIGS. 7 and 8.

The first surface 110 may receive light from a plurality of light beams 109 across a surface area having a first projected width (a₁) on the normal axis 104, as schematically indicated in FIG. 1c. Further, the received light is coupled out through the second surface 111 across a surface area having a second projected width (a₂) on the normal axis. The first distance (h₁) may be construed as a minimum separation between the touch surface 102 and the first projected width (a₁). Likewise, the second distance (h₂) corresponds to a minimum separation between the touch surface 102 and the second projected width (a₂), as indicated in the example of FIG. 1c. I.e. the light received across the first surface 110 may be shifted a distance corresponding to h₁-h₂ along the normal axis 104 and in a direction towards the touch surface 102, with the advantageous benefits as described above. The light beams 109 received across the first surface 110 may have various angles in relation to the first surface 110. Regardless, the light beams 109 coupled out from the second surface 111, in a direction substantially parallel to the touch surface 102, has undergone a shift along the normal axis 104 and towards the touch surface 102 as described above.

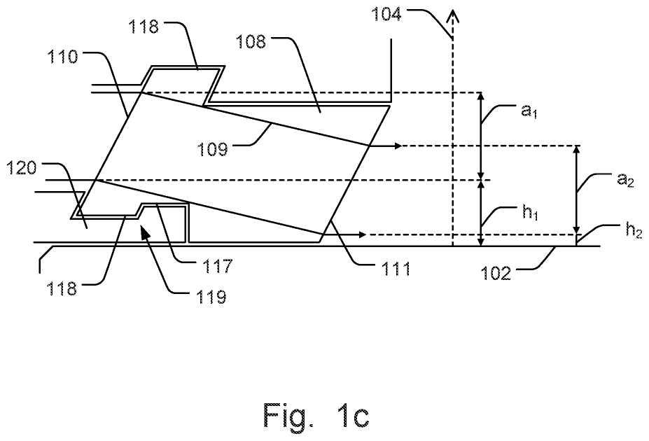

FIGS. 1-2 show various examples of the light directing element 108. Each of the first and second surfaces 110, 111, may overall comprise a tilted surface forming an acute angle (α₁, α₂) with the normal axis 104 or a lens 113, 113′, to deflect the beam of light 109 from the first surface 110 to the second surface 111, and further to direct the beam of light 109 across the touch surface 102 substantially parallel to the touch surface 102. FIGS. 1a-c and 2b-2d show examples where the first and/or second surface 110, 111, comprises a tilted surface forming an acute angle (α₁, α₂) with the normal axis 104. FIGS. 2a, 2c-d show examples where the first and/or second surface 110, 111, comprises a lens 113, 113′, configured for said deflection of the beam of light 109.

In some examples, the lens may comprise a Fresnel lens. This provides for a particularly compact lens. Different geometrical constrains of the light directing element 108 and associated assembly elements of the touch sensing apparatus 100 may thus be easier to fulfil.

Turning to FIG. 2b, the first and second surfaces 110, 111, may extend between a base surface 114 of the light directing element 108, facing the panel 101, and a top surface 115 of the light directing element 108, opposite the base surface 114. Each of the first and second surfaces 110, 111, may be tilted with respective first and second acute angles (α₁, α₂) relative the normal axis 104 so that the top surface 115 is offset from the base surface 114 in a direction 116 along the plane 103 of the touch surface 102. The direction 116 along the plane 103 extends from the perimeter 107 towards the touch surface 102 as indicated in FIG. 2b (dashed arrow 116). The light directing element 108 may thus have the general outline of a rhomboid or rhombus, where the top surface 115 is offset from the base surface 114 as described above. The second surface 111 may thus form an angle 90°+α₂ with the base surface 114 facing the panel 101, or an angle 90°−α₂ with the top surface 115. Correspondingly, the first surface 110 may form an angle 90°−α₁ with the base surface 114, or an angle 90°+α₁ with the top surface 115. The angles (α₁, α₂) and the corresponding offset distances d₁ and d₂, as indicated in FIG. 2b, may be varied to reduce the light field height and to direct the light beams 109 to be parallel with the touch surface 102 when propagating across the touch surface 102 for various configurations of the positions and dimensions of the light directing element 109, light scattering elements 121, emitters 105, detectors 106, or associated components of the touch sensing apparatus 100.

The first acute angle (α₁) and the second acute angle (α₂) may be in the range of 20-40 degrees. In one example the first acute angle (α₁) and the second acute angle (α₂) is about 30 degrees to effectively provide for a desired shift the light beams 109 as described above. In one example the first acute angle (α₁) is equal to the second acute angle (α₂).

The first surface 110 may comprise a first lens 113 to deflect the beam of light 109 towards the second surface 111. The second surface 111 may comprise a second lens 113′ to couple out the beam of light 109 through the second surface 111 so that the light beam 109 is parallel with the touch surface 102. FIG. 2a is a schematic illustration of first and second lenses 113, 113′, at respective first and second surfaces 110, 111. This provides for a particularly compact light directing element 108 in a direction along the plane 103 while attaining the desired shift of the light beams 109.

In another example, illustrated in FIG. 2c, the first surface 110 comprises a first lens 113 to deflect the beam of light towards the second surface 111, and the second surface 111 is tilted with the second acute angle (α₂) relative the normal axis 104 to deflect the beam of light 109 to be parallel with the touch surface 102.

Further, as schematically illustrated in FIG. 2d, the first surface 110 may be tilted with the first acute angle (α₁) relative the normal axis 104 to deflect the beam of light 109 towards the second surface 111, and the second surface 111 may comprise a second lens 113′ to deflect the beam of light 109 to be parallel with the touch surface 102. This allows for having a vertical profile of the light directing element 108 facing the touch surface 102 which may be advantageous in some applications. This may further provide for reducing the width of a bezel surrounding the touch surface 102 of the touch sensing apparatus 100.

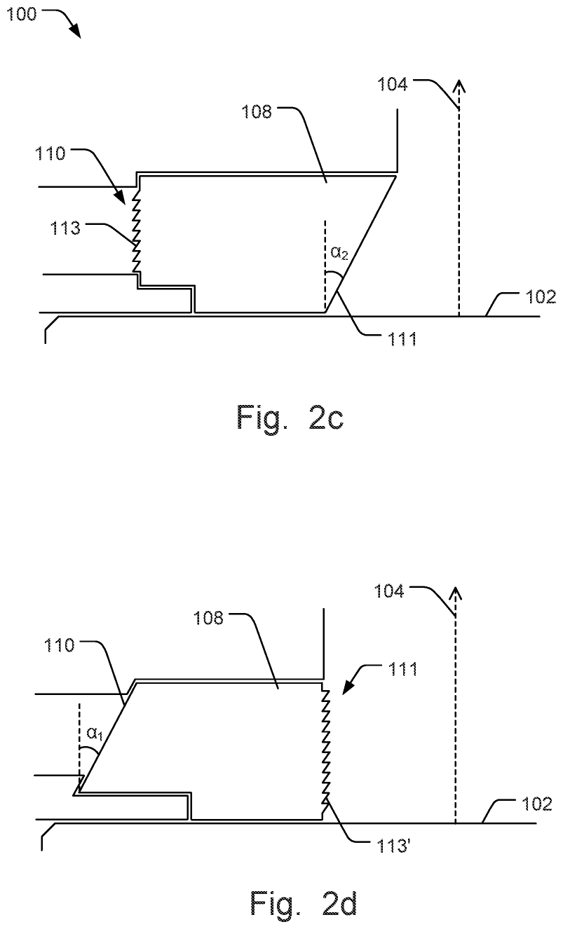

The touch sensing apparatus 100 may comprise a light transmissive sealing element 124 arranged between the tilted second surface 111 and the touch surface 102, as schematically illustrated in the example of FIG. 4. The light transmissive sealing element 124 has a first sealing surface 125 facing the tilted second surface 111 and an opposite second sealing surface 125′ extending substantially in parallel with the normal axis 104. The second sealing surface 125′ may be parallel with the normal axis 104 or tilted e.g. +−2 degrees with respect to the normal axis 104. The second sealing surface 125′ provides for further facilitating maintenance of the touch surface 102, since it may be arranged between the touch surface 102 and an adjoining frame element 135 of the touch sensitive apparatus 100 so that the second sealing surface 125′ is substantially flush with the adjoining frame element 135 as shown in FIG. 4. Having the second sealing surface 125′ substantially flush with the frame element 135 reduce the risk of accumulation of debris on the touch surface 102 adjacent the sealing surface 125′, and further a facilitated removal of such debris if needed.

The light transmissive sealing element 124 may be integral with the light directing element 108. In this case, the first sealing surface 125 may be separated from the tilted second surface 111 by a cavity 126 in the light directing element 108, as schematically illustrated in FIG. 4. This may provide for a particularly robust arrangement of the light directing element 108 and the light transmissive sealing element 124, which may also be manufactured as a single piece in an extrusion process. It is conceivable however that the light transmissive sealing element 124 may be a separate element and not connected to the light directing element 108, while still providing for the advantages as mentioned above with respect to facilitated maintenance.

The light directing element 108 may comprise a recess 117 or a protrusion 118 for interlocking with a correspondingly mating locking surface 119 of a frame element 120 along the perimeter 107 of the touch sensing apparatus 100. FIG. 1c is a schematic illustration of such fixation mechanism, utilizing interlocking surfaces 117, 118, of the light directing element 108 to fix the latter in relation to the frame element 120 of the touch sensing apparatus 100. Assembly of the touch sensing apparatus 100 can thus be facilitated since separate fixation elements, such as different adhesive elements, can be dispensed with. Shifting the light beams 109 along the normal axis 104, towards the touch surface 102, provides for utilizing portions of the light directing element 108 as such interlocking surfaces 117, 118, while at the same time reducing the height of the light field and maintaining efficient coupling of light between emitters 105 or detectors 106 with a minimum of light losses. The light directing element 108 may be mounted to the frame element 120 by sliding the interlocking surfaces 117, 118, into the corresponding mating surfaces 119 of the frame element 120. The assembly of the touch sensing apparatus 100 may thus be facilitated, which provides for a less complex and more resource efficient manufacturing process. This also provides for efficiently securing the light directing element 108 to the frame element 120, and thereby providing a robust touch sensing apparatus 100 and accurate alignment of the light directing element 108 in relation to the emitters 105, detectors 106, and the panel 101.

FIG. 1c shows an example where the light directing element 108 comprises protrusions 118 at the surface facing the panel 101 and at the opposite surface at the top of the light directing element 108. FIG. 2b shows an example where only the surface facing the panel 101 comprises a protrusion 118. Having at least one recess 117, and/or a protrusion 118 at each of the base and top surfaces 114, 115, may provide for further increasing the stability of the fixation, e.g. preventing twisting of the light directing element 108, while at the same time ensuring that stress on the light directing element 108 is avoided. It should be understood that the light directing element 108 may comprise various combinations of recesses 117 and/or protrusions 118, extending with various angles in relation to the normal axis 104, for interlocking with corresponding mating surfaces 119 of the frame element 120 while providing for the advantageous benefits as described above.

The light directing element 108 and the recess 117 and/or protrusion 118 thereof may be formed by an extrusion process as a single integrated piece. This provides for a robust and less complex fixation of the light directing element 108 to the frame element 120.

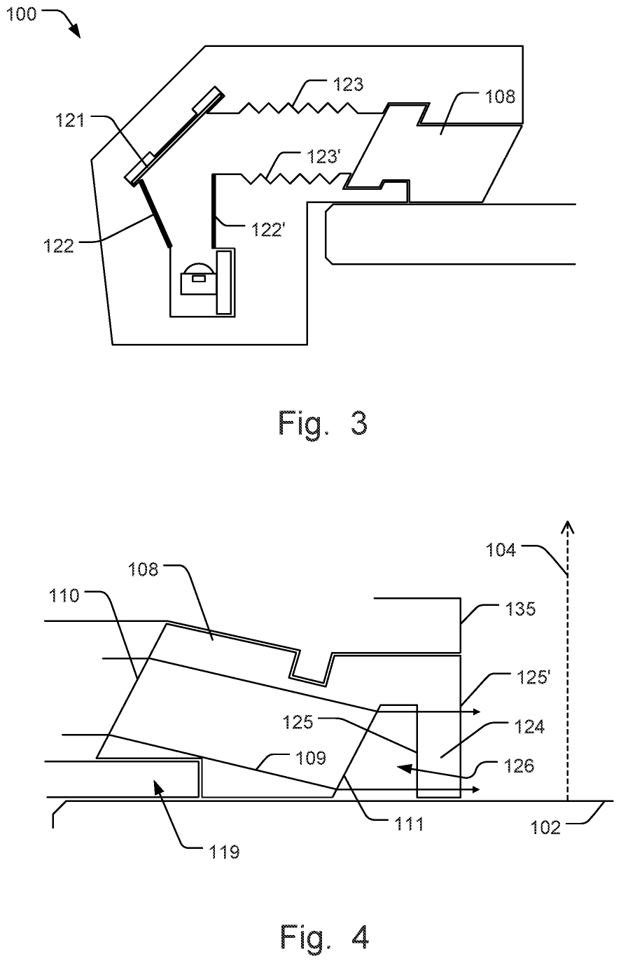

Turning to FIG. 5a, the second surface 111 may extend between a base surface 114 of the light directing element 108, facing the panel 101, and a top surface 115 of the light directing element 108, opposite the base surface 114. The top surface 115 faces a correspondingly mating frame surface 127 of a frame element 128 of the touch sensing apparatus 100. As mentioned above, the first surface 110 may receive light from a plurality of light beams 109 across a surface area having a first projected width (a₁) on the normal axis 104. In one example, the frame element 128 has a width 129 along the normal axis 104 overlapping at least a portion of the first projected width (a₁). FIG. 5b is a top view of FIG. 5a, showing light beams 109, 109′, emitted from emitter 105 and propagating through the light directing element 108 before starting to propagate over the plane 103 of the touch surface 102 (in plane view vertically above the light directing element 108 in FIG. 5b). The first light beam 109 is parallel with the direction 116, and the second light beam 109′ forms an angle φ with the direction 116. Light beams across the touch surface 102 will thus have different angles φ relative the direction 116. The light which is coupled out from light directing element 108, towards the touch surface 102, has a certain width along the normal axis 104, which may be regarded an effective aperture. The width of the effective aperture may affect the performance of the touch detection. The width of the effective aperture may be affected by the angle φ. E.g. as the angle φ increases, the effective aperture may be reduced. The effective aperture seen from the second light beam 109′ may thus be more narrow, compared to the effective aperture seen from the first light beam 109. For example, having φ=80° (second light beam 109′), the effective aperture may be 2 mm, while at φ=0° (first light beam 109), the effective aperture may be 3 mm. In this example, the separation may be 1 mm between the first and second light beams 109, 109′, along the normal axis 104 (i.e. between the adjacent light beams 109, 109′, arriving at the same height at the second surface 111 in FIG. 5a) before reaching the first surface 110. Having a frame element 128 with a width 129 along the normal axis 104 overlapping at least a portion of the first projected width (a₁) provides for limiting the effective aperture at small φ angles (e.g. for the first light beam 109) to the maximum value obtained for larger φ angles (e.g. for the second light beam 109′). Thus, in the example of FIGS. 5a-b, the effective aperture at φ close to 0° may be limited to the effective aperture at φ close to 80°, e.g. from 3 mm to 2 mm, so that the effective aperture may be 2 mm for both the first and second light beams 109, 109′. This provides for achieving a constant effective aperture across the angular range of φ and an improved performance of the touch detection.

FIG. 7 illustrates an example of a touch sensing apparatus 100 comprising a panel 101 that defines a touch surface 102 extending in a plane 103 having a normal axis 104. Although not shown, a plurality of emitters 105 and detectors 106 are arranged along a perimeter 107 of the panel 103, as described previously. A light directing element 108 is arranged adjacent the perimeter 107. The emitters 105 are arranged to emit a respective beam of light 109 and the light directing element 108 is arranged to receive the beam of light 109 through a first surface 110 and couple out the beam of light through a second surface 111 to direct the beam of light across the touch surface 102 substantially parallel to the touch surface 102. The first surface 110 extends between a base surface 114 of the light directing element 108 and a top surface 115 of the light directing element 108, opposite the base surface 114. The touch sensing apparatus 100 may comprise a seal 129 arranged between the base surface 114 and a frame element 131 of the touch sensing apparatus 100. The seal 129 may be arranged radially outside an edge 132 of the panel 101 and arranged against at least a portion of the base surface 114 extending outside the edge 132. The seal 129 may be substantially flush with the plane 103 of the touch surface 102, with respect to the normal axis 104, so that the base surface 114 is substantially flush with the plane 103 of the touch surface 102. The seal 129 may extend above the plane 103 during assembly when uncompressed, but may be subsequently compressed to be flush with the plane 103 as illustrated in FIG. 7. The base surface 114 is thus supported by the seal 129 at a height along the normal axis 104 corresponding substantially to the height at which the plane 103 extends, as illustrated in FIG. 7. The height at which the light beam 109 may propagate through the light directing element 108, in a direction parallel with the touch surface 102, may thus be minimized, since the light directing element 108 may be in direct contact with the touch surface 102 when being supported by the seal 129 as described. Having the seal 129 substantially flush with the plane 103 of the touch surface 102 provides for minimizing any interference with the light beam 109 and the light beam 109 may thus propagate through the light directing element 108 in parallel with the touch surface 102. This provides for minimizing the height of the light field across the touch surface 102, for improved performance of the touch detection as described above. The example in FIG. 7 may be combined with any features of the light directing element 108 as described above in relation to FIGS. 1-6 to further reduce the height of the light field, e.g. where first and/or second surfaces 110, 111, are tilted and/or comprising lenses, such as Fresnel lenses. It should be understood however that the example of FIG. 7 also provides the advantageous benefits from reducing the height of the light field while having a light directing element 108 without tilted first and/or second surfaces 110, 111, or lenses. A tilt of e.g. 2 degrees of the second surface 11 provides for reducing the impact of Fresnel reflexes. Fresnel reflexes may otherwise generate additional unwanted light paths that will reduce the apparent attenuation on some detection lines, especially when they run parallel to and near the second surface 111. These Fresnel reflexes may also result in artifacts and false touch information. By having a tilted second surface 111 the light may instead bounce off the second surface 111 with such an angle so that it leaves the plane 103, and thereby not interfere with the detection of the remaining light.

The seal 129 may be C-shaped as seen in the example of FIG. 7, or may have other shapes such as rectangular or J-shaped. The seal 129 provides for facilitating the sealing and fixing of the position of the light directing element 108. A sealing or fixation element 130 may be provided between the top surface 115 of the touch sensing apparatus 100 and the opposite frame element of the touch sensing apparatus 100, as schematically illustrated in FIG. 7. This provides for further sealing and/or securing the light directing element 108 in some applications.

The light directing element 108 may comprise a protrusion 118 for interlocking with a correspondingly mating locking surface 119 of a frame element 120 as exemplified in FIG. 8. This provides for securing the light directing element 108, and a facilitated assembly of the touch sensing apparatus 100, while allowing the light beams 109 to propagate through the light directing element 108 in parallel with the touch surface 102 and with a reduced height of the light field above the touch surface as described above. The example in FIG. 8 may be combined with any features of the light directing element 108 as described above in relation to FIGS. 1-6 to further reduce the height of the light field, e.g. where first and/or second surfaces 110, 111, are tilted and/or comprising lenses, such as Fresnel lenses. It should be understood however that the example of FIG. 8 also provides the advantageous benefits from reducing the height of the light field while having a light directing element 108 without tilted first and/or second surfaces 110, 111, or lenses. A tilt of e.g. 2 degrees of the second surface 11 may be provided to reduce unwanted reflexes that may result in false scan lines.

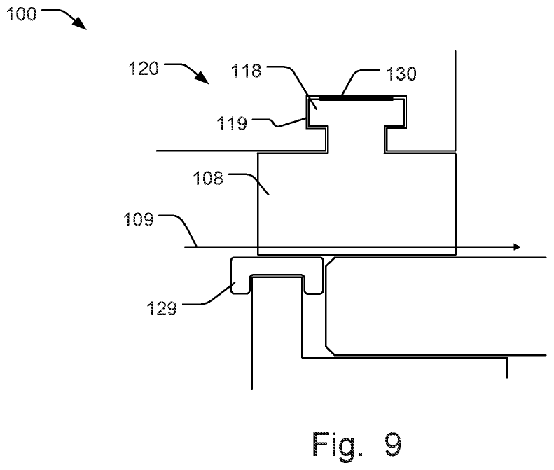

Having a light directing element 108 comprising a protrusion 118 for interlocking with a correspondingly mating locking surface 119 of a frame element 120 may provide for sufficiently securing the light directing element 108, without the seal 129, although such seal may be provided in one example, as illustrated in FIG. 9. The example of FIG. 9 also shows a sealing or fixation element 130 between the protrusion 118 and the opposite frame element of the touch sensing apparatus 100. This provides for further sealing and/or securing the light directing element 108 in some applications. The sealing or fixation element 130 may comprise a coextruded polymer such as a thermoplastic polyurethane.

The touch sensing apparatus 100 may comprise a diffusive light scattering element 121, 121′, along a light path 112 between the emitters 105 or detectors 106 and the touch surface 102, as schematically illustrated in e.g. FIG. 1a. The diffusive light scattering element 121, 121′, may be formed as a film that may be slotted into place using an extruded pocket 133 in a frame element 134, as illustrated in FIG. 1a. The emitters 105 may thus be arranged to emit a respective beam of light 109 onto the diffusive light scattering element 121 to generate light that propagates in a wide range of directions, so as to reach all or many of the detectors 106 arranged around the perimeter 107. Diffuse reflection refers to reflection of light from a surface such that an incident ray is reflected at many angles rather than at just one angle as in “specular reflection”. Thus, a diffusively reflecting element will, when illuminated, emit light by reflection over a large solid angle at each location on the element. The diffuse reflection is also known as “scattering”. Accordingly, the diffusive light scattering element 121, 121′, will act as a light source (“secondary light source”) to emit diffuse light. Thus, each diffusive light scattering element 121, 121′, will act as a light source that diffusively emits “detection light” for receipt by a detector 106. This provides for achieving a broad width of the scanlines across the touch surface 102 and an improved touch detection performance. Hence, the detectors 106 may be arranged to receive detection light generated as the propagating light impinges on a corresponding diffusive light scattering element 121′, as schematically shown in FIG. 4.

The diffusive light scattering element 121, 121′, may be configured as an essentially ideal diffuse reflector, also known as a Lambertian or near-Lambertian diffuser, which generates equal luminance from all directions in a hemisphere surrounding the diffusive light scattering element 121, 121′. Many inherently diffusing materials form a near-Lambertian diffuser. In an alternative, the diffusive light scattering element 121, 121′, may be a so-called engineered diffuser, e.g. a holographic diffuser. The engineered scattering element 121, 121′, may also be configured as a Lambertian diffuser. In a variant, the engineered diffuser is tailored to promote diffuse reflection into certain directions in the surrounding hemisphere, in particular to angles that provides for the desired propagation of light above and across the touch surface 102.

The diffusive light scattering element may be configured to exhibit at least 50% diffuse reflection, and preferably at least 90% diffuse reflection.

Many materials exhibit a combination of diffuse and specular reflection. Specularly reflected light may result in coupling losses between the emitter, detector and the associated component therebetween. In some examples it may thus be advantageous that the relation between diffusive and specular reflection is high for the diffusive light scattering element 121, 121′. Sufficient performance may be achieved when at least 50% of the reflected light is diffusively reflected. In some examples the diffusive light scattering element 121, 121′, is designed to reflect incoming light such that at least about 60%, 70%, 80%, 90%, 95%, or 99% of the reflected light is diffusively reflected.

The diffusive light scattering element 121, 121′, may comprise materials that are inherently diffusing and where diffuse reflection is promoted in certain directions. Thus, the diffusive light scattering element 121, 121′, may comprise a material of varying refractive index.

The diffusive light scattering element 121, 121′, may be implemented as a coating, layer or film applied to a reflective surface, e.g. by painting, spraying, lamination, gluing, etc.

In one example, the scattering element 121, 121′ is implemented as matte white paint or ink applied to a reflective surface. In order to achieve a high diffuse reflectivity, it may be preferable for the paint/ink to contain pigments with high refractive index. One such pigment is TiO₂, which has a refractive index n=2.8. It may also be desirable, e.g. to reduce Fresnel losses, for the refractive index of the paint filler and/or the paint vehicle to match the refractive index of the surface material. The properties of the paint may be further improved by use of EVOQUE™ Pre-Composite Polymer Technology provided by the Dow Chemical Company.

There are many other coating materials for use as a diffuser that are commercially available, e.g. the fluoropolymer Spectralon, polyurethane enamel, barium-sulphate-based paints or solutions, granular PTFE, microporous polyester, GORE® Diffuse Reflector Product, Makrofol® polycarbonate films provided by the company Bayer AG, etc.

Alternatively, the diffusive light scattering element 121, 121′, may be implemented as a flat or sheet-like device, e.g. the above-mentioned engineered diffuser or white paper, which is attached to an external surface by an adhesive. According to other alternatives, the diffusive light scattering element 121, 121′, may be implemented as a semi-randomized (non-periodic) micro-structure on an internal surface or an external surface with an overlying coating of reflective material.

The touch sensing apparatus may comprise at least one reflective surface 122, 122′, arranged in the light path between the light scattering element 121, 121′, and the plurality of emitters 105 and detectors 106. This provides for enhancing reflection of the light from the emitters 105 to the light scattering element 121, or from the light scattering element 121′ to the detectors 106. Loss of light can thus be minimized and signal to noise ratio improved.

The at least one reflective surface 122, 122′, may comprise a specularly reflective surface or a diffusively reflective surface.

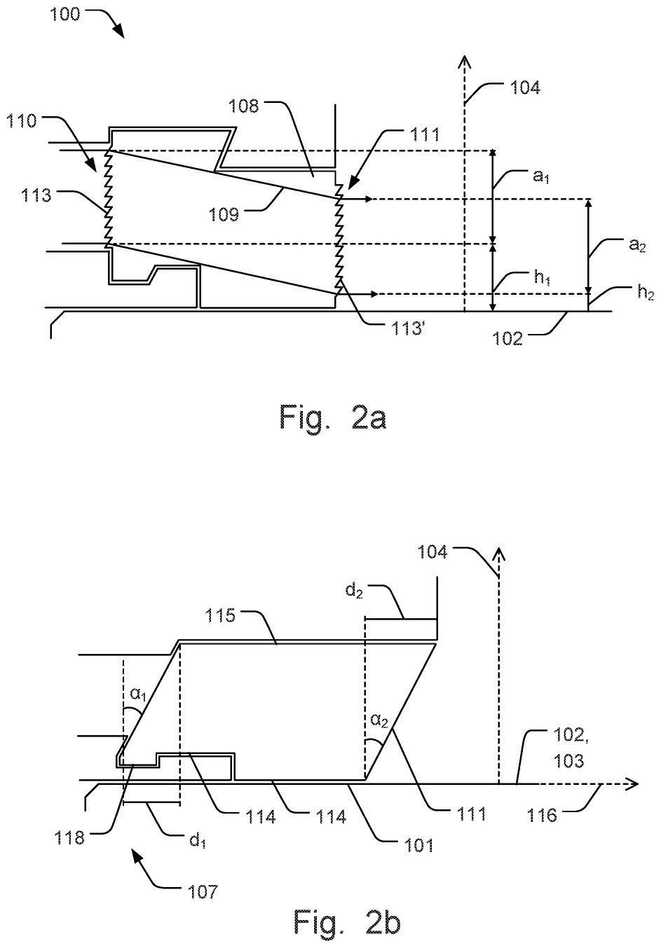

The touch sensing apparatus 100 may comprise at least one absorbing surface 123, 123′, arranged along a light path 112 between the emitters 105 or detectors 106 and the touch surface 102 to confine light propagation to a determined angular range in relation to the touch surface 102, as schematically illustrated in FIG. 3. This provides for blocking e.g. ambient light to propagate to the detectors 106, as well as reducing the angular spread of emitted light that reaches the first surface 110 of the light directing element 108. The touch detection accuracy may thus be improved, as unwanted light reflections are minimized while loss of light relevant for the detection process is minimized.

The panel 101 may made of any solid material (or combination of materials) that transmits a sufficient amount of light in the relevant wavelength range to permit a sensible measurement of transmitted energy. Such material includes glass, poly(methyl methacrylate) (PMMA) and polycarbonates (PC). The panel 101 may be designed to be overlaid on or integrated into a display device or monitor (not shown).

As used herein, the emitters 105 may be any type of device capable of emitting radiation in a desired wavelength range, for example a diode laser, a VCSEL (vertical-cavity surface-emitting laser), an LED (light-emitting diode), an incandescent lamp, a halogen lamp, etc. The emitter 105 may also be formed by the end of an optical fiber. The emitters 105 may generate light in any wavelength range. The following examples presume that the light is generated in the infrared (IR), i.e. at wavelengths above about 750 nm. Analogously, the detectors 106 may be any device capable of converting light (in the same wavelength range) into an electrical signal, such as a photo-detector, a CCD device, a CMOS device, etc.

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims.

For example, the specific arrangement of emitters and detectors as illustrated and discussed in the foregoing is merely given as an example. The inventive coupling structure is useful in any touch-sensing system that operates by transmitting light, generated by a number of emitters, inside a light transmissive panel and detecting, at a number of detectors, a change in the received light caused by an interaction with the transmitted light at the point of touch.

1. A touch sensing apparatus comprising:
a panel that defines a touch surface extending in a plane having a normal axis,
a plurality of emitters and detectors arranged along a perimeter of the panel,
a light directing element arranged adjacent the perimeter,
wherein the emitters are arranged to emit a respective beam of light and the light directing element is arranged to receive the beam of light through a first surface and couple out the beam of light through a second surface to direct the beam of light across the touch surface substantially parallel to the touch surface,
wherein the beam of light is received through the first surface at a first distance from the touch surface and is deflected by the light directing element to the second surface to couple out the beam of light at a second distance from the touch surface, wherein the first distance is greater than the second distance.

2. A touch sensing apparatus according to claim 1, wherein the first surface receives light from a plurality of light beams across a surface area having a first projected width on the normal axis,
wherein the received light is coupled out through the second surface across a surface area having a second projected width on the normal axis,
wherein said first distance is a minimum separation between the touch surface and the first projected width, and the second distance is a minimum separation between the touch surface and the second projected width.

3. A touch sensing apparatus according to claim 1, wherein each of the first and second surfaces comprises;
a tilted surface forming an acute angle with the normal axis or
a lens, to deflect the beam of light from the first surface to the second surface and direct the beam of light across the touch surface substantially parallel to the touch surface.

4. A touch sensing apparatus according to claim 3, wherein said lens comprises a Fresnel lens.

5. A touch sensing apparatus according to claim 3,
wherein the first and second surfaces extend between a base surface of the light directing element, facing the panel, and a top surface of the light directing element, opposite the base surface, and
wherein each of the first and second surfaces are tilted with respective first and second acute angles relative the normal axis so that the top surface is offset from the base surface in a direction along the plane from the perimeter towards the touch surfaced.

6. A touch sensing apparatus according to claim 5, wherein the first and second acute angles are in the range of 20-40 degrees from the normal axis.

7. A touch sensing apparatus according to claim 5, wherein the first acute angle is equal to the second acute angle.

8. A touch sensing apparatus according to claim 3, wherein the first surface comprises a first lens to deflect the beam of light towards the second surface, and
wherein the second surface comprises a second lens to couple out the beam of light through the second surface so that the light beam is parallel with the touch surface.

9. A touch sensing apparatus according to claim 3, wherein the first surface comprises a first lens to deflect the beam of light towards the second surface, and
wherein the second surface is tilted with a second acute angle relative the normal axis to deflect the beam of light to be parallel with the touch surface.

10. A touch sensing apparatus according to claim 5, comprising a light transmissive sealing element arranged between the tilted second surface and the touch surface, wherein the light transmissive sealing element has a first sealing surface facing the tilted second surface and an opposite second sealing surface extending in parallel with the normal axis.

11. A touch sensing apparatus according to claim 10, wherein the light transmissive sealing element is integral with the light directing element, and wherein the first sealing surface is separated from the tilted second surface by a cavity in the light directing element.

12. A touch sensing apparatus according to claim 3, wherein the first surface is tilted with a first acute angle relative the normal axis to deflect the beam of light towards the second surface, and
wherein the second surface comprises a second lens to deflect the beam of light to be parallel with the touch surface.

13. A touch sensing apparatus according to claim 1, wherein the light directing element comprises a recess or a protrusion for interlocking with a correspondingly mating locking surface of a frame element along the perimeter of the touch sensing apparatus.

14. A touch sensing apparatus according to claim 13, wherein the light directing element and the recess and/or protrusion thereof are formed by an extrusion process.

15. A touch sensing apparatus according to any of claim 1, comprising a diffusive light scattering element along a light path between the emitters or detectors and the touch surface.

16. A touch sensing apparatus according to claim 15, comprising at least one reflective surface arranged in the light path between the light scattering element and the plurality of emitters and detectors.

17. A touch sensing apparatus according to claim 16, wherein the at least one reflective surface comprises a specularly reflective surface or a diffusively reflective surface.

18. A touch sensing apparatus according to claim 1, comprising at least one absorbing surface arranged along a light path between the emitters or detectors and the touch surface to confine reflections of light to a determined angular range in relation to the touch surface.

19. A touch sensing apparatus according to claim 1, wherein the second surface extends between a base surface of the light directing element, facing the panel, and a top surface of the light directing element, opposite the base surface, wherein the top surface faces a correspondingly mating frame surface of a frame element of the touch sensing apparatus,
wherein the frame element has a width along the normal axis overlapping at least a portion of the first projected width.

20. A touch sensing apparatus according to any of claim 1, wherein the first surface extends between a base surface of the light directing element and a top surface of the light directing element, opposite the base surface,
a seal arranged between the base surface and a frame element,
wherein the seal is arranged radially outside an edge of the panel and is arranged against at least a portion of the base surface extending outside the edge,
wherein the seal is substantially flush with the plane of the touch surface with respect to the normal axis, so that the base surface is substantially flush with the plane of the touch surface.
